(19) United States
(12) Patent Application Publication
(10) Pub. No.: US 2008/0216801 A1
(43) Pub. Date: Sep. 11, 2008

(54) FUEL SUPPLY SYSTEM

(75) Inventors: Shigeki KANAMARU, Tokyo (JP); Hiroshi YOSHIOKA, Tokyo (JP)

Correspondence Address: SUGHRUE-265550, 2100 PENNSYLVANIA AVE. NW, WASHINGTON, DC, 20037-3213, US

(73) Assignee: MITSUBISHI ELECTRIC CORPORATION, Tokyo (JP)

(21) Appl. No.: 11/835,514

(22) Filed: Aug. 8, 2007

(30) Foreign Application Priority Data
Mar. 7, 2007 (JP) 2007-057517

(51) Int. Cl. F02M 37/04

(52) U.S. Cl. 123/509; 123/511

(57) ABSTRACT

A fuel supply system provided in a fuel tank includes: a fuel pump that sucks fuel reserved within the fuel tank via a suction filter and discharges the sucked fuel; a pressure regulator that maintains pressure of the fuel discharged from the fuel pump within a predetermined range; a pump holder that holds the fuel pump and the pressure regulator; and a cushioning rubber extending in radial and axial directions of the fuel pump between the pump holder and the fuel pump for damping vibrations associated with driving of the fuel pump. Excess fuel is introduced in a flow path from the pressure regulator to the suction filter. The flow path includes: a gap defined between the pump holder and the cushioning rubber; and a gap defined between the cushioning rubber and the fuel pump.

### CROSS-REFERENCE TO RELATED APPLICATIONS

This application is based upon and claims the benefit of priority from Japanese Patent Application No. 2007-057517, filed on Mar. 7, 2007, the entire contents of which are incorporated herein by reference.

### BACKGROUND OF THE INVENTION

1. Field of the Invention

The present invention relates to a fuel supply system for feeding under pressure fuel within a fuel tank to injectors and the like of an internal combustion engine of a vehicle and more particularly to the reduction of noise generated from the fuel supply system.

2. Description of the Related Art

By means of the recent technical innovation, noise generated from vehicles (in particular, motor vehicles fueled by gasoline) tends to be reduced. This reduction of noise largely owes not only a reduction of vibrations or noise generated from an engine but also improvements in an engine starting system and a vehicle generator and a reduction of operation noise of solenoid valves, as well as improvements in elastic supporting constructions for power train units such as the engine and a transmission. As a result, the quietness of the vehicle has been increased remarkably and still continues to be increased further.

The quietness of the vehicle constitutes a main factor to determine the sense-related quality of the vehicle. Therefore, operation noise of a fuel system responsible for stable fuel supply to injectors, which is generated in association with driving thereof, cannot be an exception any longer. In recent years, it is an increasing tendency for the fuel supply system to be provided within a fuel tank in order to secure an accommodating capacity within an engine compartment. However, it is necessary to avoid deterioration of the riding comfort and the product quality, due to the operation noise of the fuel supply system propagating through the fuel tank to be eventually transmitted to the inside of a passenger compartment, which results in a reduction in the sense-related quality of the vehicle, in other words, the driver and other occupants in the vehicle having to feel uneasiness or uncomfortableness.

JP-A-2000-45900 (lines 41 to 49 in a left-side column on page 3, and FIG. 2; hereinafter referred to as Document 1) discloses a fuel supply device including a vibration isolating rubber provided between a fuel pump and a bracket for holding the posture of the fuel pump and having a damping portion directed toward a fitting portion with the bracket, thereby effectively damping vibrations of the fuel pump. JP-A-2002-155823 (lines 6 to 10 in a left-hand side column on page 5, FIG. 1; hereinafter referred to as Document 2) discloses a fuel supply device that allows excess fuel from a pressure regulator to be introduced into a fuel tank through a sedimentation flow path formed in a space defined by an inner peripheral wall of a pump holder, an outer periphery of a fuel pump, a lower end surface of a main housing and a vibration absorber, thereby reducing discharge noise of a pressure regulator.

Although the vibration isolating rubber (Document 1) and the vibration absorber (Document 2) can absorb vibrations by fixedly holding the fuel pump is fixedly held, it is difficult to sufficiently suppress the propagation of noise to the fuel tank. This is because, in the case of Document 2 (see FIG. 5 of Document 2), the surfaces of the fuel pump and the vibration absorber and the surfaces of the vibration isolating bed and the pump holder are arranged very closely to each other in order to secure the sedimentation flow path. In this regard, in Document 1, in consideration of transmission of vibrations to the bracket, the area of a distal end of a projection is made extremely small to transmit vibrations thereto by way of the damping portion, so that the damping effect can be expected to be provided to some extent. However, since a projecting portion (denoted by reference numeral 12 in Document 1) of the fuel pump and a pump abutment surface (denoted by reference numeral 22a in Document 1) of the vibration isolating rubber are in tight contact with each other over a semicircular shape, it is sufficiently expected that original vibrations themselves are large, and hence, it is natural to consider that there has been a certain limitation to sufficient suppression of noise propagation from the bracket and, furthermore, the fuel tank only by damping of the originally large vibrations. While the main object of Document 2 is to capture foreign substances contained in excess fuel from the sedimentation flow path, even though the excess fuel is caused to flow by way of the sedimentation flow path, the excess fuel is eventually directly discharged back into the fuel tank. In particular, in the event that the fuel level is situated below an outlet (FIG. 8 of Document 2) of the sedimentation flowpath, collision noise generated when the excess fuel is discharged back into the fuel tank is propagated through the fuel tank to be transmitted to the inside of the passenger compartment, whereby the sense-related quality of the vehicle may be reduced.

The invention has been made in view of the above circumstances, and an object thereof is to provide a fuel supply system capable of suppressing noise associated with discharge of excess fuel from a pressure regulator and propagation of vibrations associated with driving of a fuel pump.

### SUMMARY OF THE INVENTION

According to an aspect of the invention, there is provided a fuel supply system provided in a fuel tank including: a fuel pump that sucks fuel reserved within the fuel tank via a suction filter and discharges the sucked fuel; a pressure regulator that maintains pressure of the fuel discharged from the fuel pump within a predetermined range; a pump holder that holds the fuel pump and the pressure regulator; and a cushioning rubber extending in radial and axial directions of the fuel pump between the pump holder and the fuel pump for damping vibrations associated with driving of the fuel pump, wherein excess fuel is introduced in a flow path from the pressure regulator to the suction filter, the flow path including: a gap defined between the pump holder and the cushioning rubber; and a gap defined between the cushioning rubber and the fuel pump.

### BRIEF DESCRIPTION OF THE DRAWINGS

FIG. 1 is an external perspective view of a fuel supply system according to an embodiment of the invention;

FIG. 2 is a cross-sectional view of the fuel supply system shown in FIG. 1;

FIGS. 3A to 3C are external perspective views of a cushioning rubber 10 in FIG. 2;

FIG. 4 is a cross-sectional view taken along the line A-A in FIG. 2; and

FIGS. 5A to 5C are explanatory views illustrating flow paths for excess fuel in FIG. 2.

### DETAILED DESCRIPTION OF THE PREFERRED EMBODIMENTS

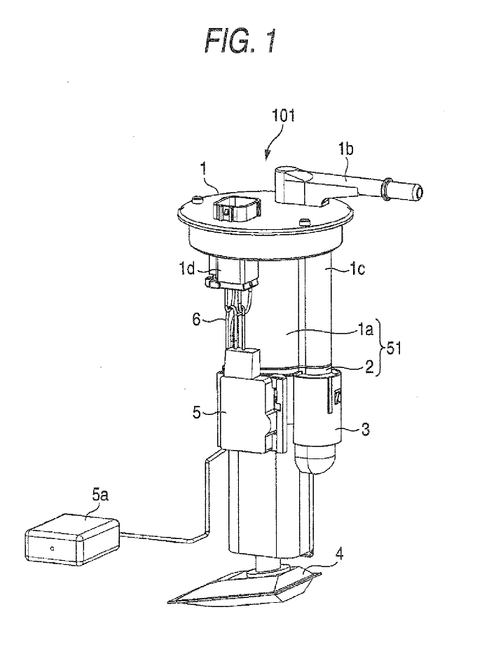

In FIG. 1, a fuel supply system 101 roughly includes: a flange 1 that is formed from an insulating resin and integrally molded to include an upper case 1a, a discharge pipe 1b to which a fuel hose or the like connecting to an injector, not shown, is connected, a return piping 1c and a connector 1d; a lower case 2 that is also made from an insulating resin and is secured to the upper case 1a to form a filter case 51; a pump holder 3 that is fitted with the lower case 2 through, for example, snap-fit for holding a fuel pump (described later); a suction filter 4 that is inserted from an opening in the pump holder 3 so as to be fitted in a suction port of the fuel pump; and a fluid level detector 5 that is mounted on a side of the lower case 2 and includes a float 5a for detecting a fuel level of fuel within a fuel tank. As is widely known, lead wires 6 from the connector 1d are a driving wire connecting to the fuel pump, a signal wire connecting to the fluid level detector 5 and a ground wire (described later).

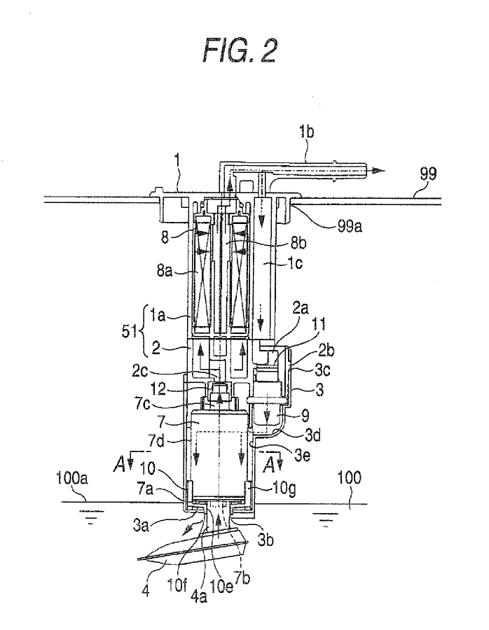

As is shown in FIG. 2, the fuel supply system 101 is accommodated in a fuel tank 99 of a vehicle in such a manner that an opening 99a in the fuel tank is closed by the flange 1, so as to supply fuel 100 sucked from the fuel tank 99 by a fuel pump 7 to an injector side via a high-pressure filter 8 incorporated in the upper case 1a. The suction filter 4 captures foreign substances contained in fuel in the fuel tank 99, and the high-pressure filter 8 captures foreign substances that cannot be captured by the suction filter 4 and other foreign substances including dust resulting from wear of a brush, a commutator and the like (not shown) provided in the fuel pump 7. In addition, the pressure of fuel supplied to injectors is maintained at a predetermined value by a pressure regulator 9. Excess fuel that results from the maintenance of fuel pressure at the predetermined value is discharged from the pressure regulator 9 by way of the return piping 1c and reaches the suction filter 4. The discharging of excess fuel and a cushioning rubber 10 that is interposed between the fuel pump 7 and the pump holder 3 when holding the fuel pump 7 in the pump holder 3 will be described later in detail.

An assembly procedure of the fuel supply system 101 will be described The high-pressure filter 8 is inserted from a lower side of the upper case 1a as viewed in the drawing so that the high-pressure filter 8 abut on a ceiling of the upper case 1a, which allows the high-pressure filter 8 to communicate with the discharge pipe 1b and lower end faces of the upper case 1a to be flush with the high-pressure filter 8. Since not only the upper case 1a but also the high-pressure filter 8 are secured to the lower case 2, for example, by heat plate welding the lower case 2 to the lower end faces of the upper case 1a, as is described above, what is formed by securing the upper case 1a and the lower case 2 together is referred to as the filter case 51. Static electricity is generated when fuel passes through an element 8a of the pressure-filter 8, and the generated static electricity is stored in an inner tube 8b which is formed from a conductive resin and by which the element 8a is sandwiched and held. Therefore, it is preferable that a terminal member (not shown) formed from a conductive resin is welded together with the inner tube 8b to be exposed from the filter case 51 when the heat plate welding is performed, and the ground wire that has been described above is connected to the terminal member, thereby easily discharging the static electricity.

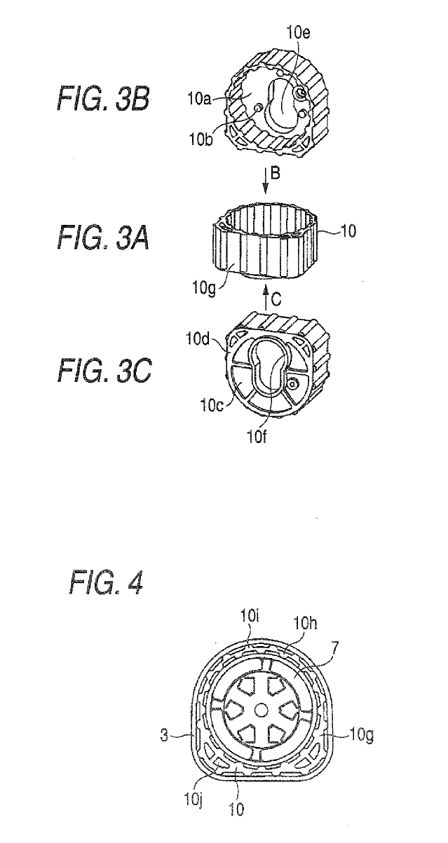

The cushioning rubber 10 is laid on an inner bottom 3a of the pump holder 3, and thereafter, the fuel pump 7 is inserted into the pump holder 3. As shown in FIGS. 3B and 3C, the cushioning rubber 10 has a plurality of projections 10b provided on an inner bottom 10a that faces a bottom side 7a of the fuel pump 7 and a plurality of convex-shaped portions 10d provided on an outer bottom 10c that faces the an inner bottom 3a of the pump holder 3, whereby the posture of the fuel pump 7 is properly held by virtue of contact between the projections 10b and the bottom side 7a and contact between the convex-shaped portions 10d and the inner bottom 3a. Furthermore, an opening 3b and an opening 10e are provided substantially concentrically in the pump holder 3 and the cushioning rubber 10, respectively, and a suction port 7b of the fuel pump 7 is positioned in these openings 3b, 10e. Namely, by inserting the connecting portion 4a into the openings 3b, 10e, the suction port 7b and a connecting portion 4a of the suction filter 4 are allowed to communicate with each other. In addition, since a opened projection 10f that follows the shape of the opening 10e is provided on the opening 10e to extend perpendicularly towards the suction filter 4 (downward in FIG. 2), the opening 3b is opened slightly more broadly than the opening 10e by an extent equal to the thickness of the opened projection 10f so that the opened projection 10f can inserted into the opening 3b when the cushioning rubber 10 is laid.

The pressure regulator 9 is liquid-tightly fitted in a terminal end 2a of a return flow path of the lower case 2 via an O-ring 11, and thereafter, an engagement hole 3c in the pump holder 3 is engaged with an engagement projection 2b, whereby the lower case 2 (the filter case 51) is engaged with the pump holder 3 through snap-fit. By this engagement, the pressure regulator 9 is held in the pump holder 3 as well as a connecting pipe 12 fitted on a discharge port 7c of the fuel pump 7 is securely and liquid-tightly fitted in a fuel suction port 2c provided in the lower case 2. The fuel suction port 2c communicates with the element 8a, and as a result, a fuel flow path from the suction filter 4 to the discharge pipe 1b is secured. Then, the fluid level detector 5 is mounted on what has been assembled heretofore, and the lead wires 6 are connected to the connector 1d, whereby the fuel supply system 101 illustrated in FIG. 1 is built up.

The operation of the fuel supply system 101 will be described based on the configuration that has been described above. Namely, when a current is supplied from a battery (not shown) to the fuel pump 7 via the connector 1d and the lead wire 6, a shaft (not shown) within the fuel pump 7 rotates, and an impeller (not shown) rotates together with the shaft as a rotational shaft. In conjunction with the rotation of the shaft and the impeller, the fuel 100 within the fuel tank 99 is introduced into the fuel pump 7 from the suction port 7c after foreign substances contained in the fuel has been removed at the suction filter 4 and is discharged from the discharge port 7c. The fuel, which is pressurized and discharged, is then introduced into the element 8a. After the element 8a captures foreign substances including the foreign substances having passed through the suction filter 4 and dust resulting from wear of the brush and the like of the fuel pump, and the fuel is thereafter supplied to the injectors via the discharge pipe 1b. In addition, as described above, the pressure of the fuel supplied to the injectors is held at the predetermined value by the pressure regulator 9, and as a result of the pressure of the fuel being held at the predetermined value, fuel which becomes excess is discharged from the pressure regulator 9 by way of the return piping 1c. The fuel so discharged is to be sucked up again via the suction filter 4.

While operation noise is generated in association with the rotation or driving of the fuel pump 7, in this embodiment, since the fuel pump 7 is encased by the pump holder 3 and the lower case 2 so as to reduce the exposure of the fuel pump 7 to as low a level as possible, the emission of the operating noise so generated can be suppressed. In addition, as is obvious from the FIGS. 2 or 3, a wall 10g is provided on the cushioning rubber 10 to extend upwards as viewed in FIG. 2 so as to cover an outer circumferential surface 7d of the fuel pump 7. This wall 10g has, as shown in FIG. 4, first ribs 10h provided on an inner circumferential surface substantially at equal intervals and second ribs 10i provided on an outer circumferential surface thereof substantially at equal intervals to be interposed when the cushioning rubber 10 abuts on the fuel pump 7 and the pump holder 3, respectively. Consequently, since the ribs, together with the projections 10b and the convex-shaped portions 10d, function to reduce contact areas between the fuel pump 7 and the cushioning rubber 10 and between the cushioning rubber 10 and the pump holder 3 to as low a level as possible, propagation of vibrations from the fuel pump 7 to the pump holder 3 can be suppressed. Namely, although the cushioning rubber 10 is interposed between the fuel pump 7 and the pump holder 3 in order to properly hold the posture of the fuel pump 7, together with the suppression of the emission of the operation noise that has been described before, transmission of the noise to the inside of the passenger compartment via the flange 1 and the fuel tank 99 can be expected to be reduced largely. In addition, the fuel pump 7 and the cushioning rubber 10 is integrated with each other by covering the outer circumferential surface 7d by the wall log, and when above-described assembling the fuel supply system 101, the integrated fuel pump and cushioning rubber may be inserted into the pump holder 3. Therefore, there can be provided an auxiliary advantage that the assembling properties of the fuel supply system 101 can be improved.

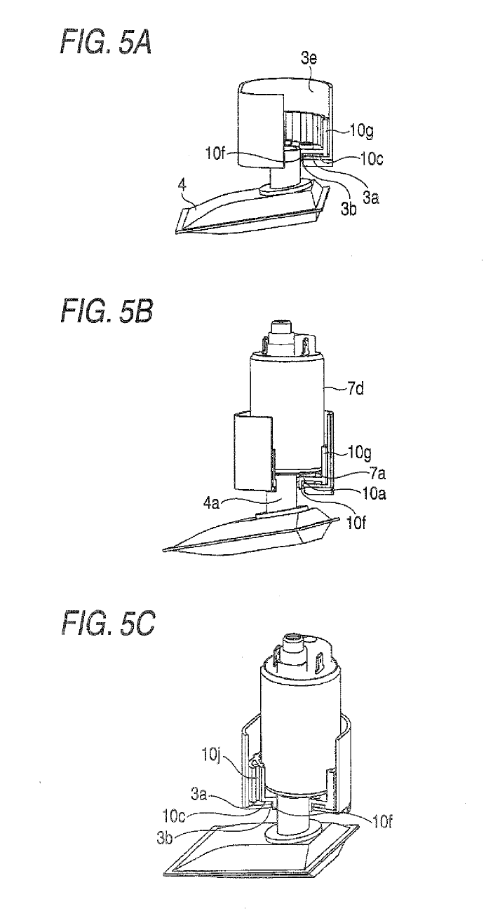

As shown in FIG. 2, a guide portion 3d for excess fuel is provided in the pump holder 3 at a position which faces a discharge port of the pressure regulator 9. Consequently, while a jet flow of fuel from the discharge port flows downward along an inner wall 3e of the pump holder 3 via the guide portion 3d toward the openings 3b, 10e. Flow paths of excess fuel are to reach the suction filter 4, as is shown in FIGS. 5A to 5C, by way of:

(1) between the inner wall 3e and the wall 10g=>between the inner bottom 3a and the outer bottom 10c=>between the opening 3b and the opened projection 10f (see FIG. 5A);

(2) between the outer circumferential surface 7a and the wall 10g=>between the bottom side 7a and the inner bottom 10a=>between the connecting portion 4a and the opened projection 10f (see FIG. 5B); and

(3) a hole 10j=>between the inner bottom 3a and the outer bottom 10c=>opening 3d and the opened projection 10f (see FIG. 5C). Namely, since the jet flow of fuel from the discharge port is prevented from directly colliding against a fuel surface 100a, together with the enclosure of the pressure regulator 9 by the pump holder 3, the generation of noise can be suppressed.

In addition, since the excess fuel is divided into the three flow paths and reaches the suction filter 4 as described above, the excess fuel can be sucked into the fuel tank efficiently for reuse. In addition, since any of the three flow paths is formed into a thin space, the momentum of the jetting flow of fuel from the discharge port can be weakened sufficiently. As a result, since excess fuel in which bubbles having existed in the jetting flow of fuel are removed flows into the suction filter 4, this also assists in realizing the efficient suction for reuse. Furthermore, although swelling of the cushioning rubber 10 is anticipated due to the cushioning rubber 10 being submerged in excess fuel at all times, since an increase in volume due to such swelling is absorbed by opposite surfaces of the first ribs 10h or the second ribs 10i which are arranged in the staggered fashion (or in other words, between the adjacent ribs (10h or 10i), there is no fear that a failure of the cushioning rubber 10 is called for.

What is claimed is:

1. A fuel supply system provided in a fuel tank comprising:
a fuel pump that sucks fuel reserved within the fuel tank via a suction filter and discharges the sucked fuel;
a pressure regulator that maintains pressure of the fuel discharged from the fuel pump within a predetermined range;
a pump holder that holds the fuel pump and the pressure regulator; and
a cushioning rubber extending in radial and axial directions of the fuel pump between the pump holder and the fuel pump for damping vibrations associated with driving of the fuel pump,
wherein excess fuel is introduced in a flow path from the pressure regulator to the suction filter, the flow path comprising: a gap defined between the pump holder and the cushioning rubber; and a gap defined between the cushioning rubber and the fuel pump.

2. The fuel supply system according to claim 1,
wherein the cushioning rubber includes first ribs and second ribs,
wherein the first ribs are provided on an inner circumferential surface to abut on an outer circumferential surface of the fuel pump and are spaced at substantially equal intervals along a circumference of the cushioning rubber around an axial direction of the cushioning rubber,
wherein the second ribs are provided on an outer circumferential surface to abut on an inner circumferential surface of the pump holder and are spaced at substantially equal intervals along the circumference of the cushioning rubber around the axial direction of the cushioning rubber.

3. The fuel supply system according to claim 2, further comprising a connecting portion provided on the suction filter to be securely fitted in a suction port of the fuel pump,
wherein an opening is provided in each of the pump holder and the cushioning rubber to allow the connecting portion to be inserted.

4. The fuel supply system according to claim 2, wherein the first ribs and the second ribs are staggered arranged.
